(19) United States
(12) Patent Application Publication
(10) Pub. No.: US 2025/0014270 A1
(43) Pub. Date: Jan. 9, 2025

(54) IMAGE PRE-PROCESSING METHOD FOR VIRTUAL DRESSING, VIRTUAL DRESSING SYSTEM, AND COMPUTER-READABLE STORAGE MEDIUM

(71) Applicant: Wistron Corporation, New Taipei City (TW)

(72) Inventors: Guan Yi Chian, New Taipei City (TW); Kuan-I Chung, New Taipei City (TW)

(73) Assignee: Wistron Corporation, New Taipei City (TW)

(21) Appl. No.: 18/451,076

(22) Filed: Aug. 16, 2023

(30) Foreign Application Priority Data
Jul. 5, 2023 (TW) 112125080

(51) Int. Cl. G06T 17/00; G06T 5/50; G06T 7/194; G06V 10/25; G06V 10/764

(52) U.S. Cl. CPC G06T 17/00; G06T 5/50; G06T 7/194; G06V 10/25; G06V 10/764; G06T 2207/20044; G06T 2207/20132; G06T 2207/20221; G06T 2207/30196

(57) ABSTRACT

The embodiments of the disclosure provide an image pre-processing method for virtual dressing, a virtual dressing system, and a computer-readable storage medium. The method is described below. A cloth image including a cloth and a human body image including a human body are obtained. A human skeleton image corresponding to the human body is generated. A skeleton image area in the human skeleton image is determined based on the cloth image. A specific image area corresponding to the skeleton image area is cropped from the human body image.

### CROSS-REFERENCE TO RELATED APPLICATION

This application claims the priority benefit of Taiwan application serial no. 112125080, filed on Jul. 5, 2023. The entirety of the above-mentioned patent application is hereby incorporated by reference herein and made a part of this specification.

### BACKGROUND

### Technical Field

The disclosure relates to an image pre-processing method, and more particularly, to an image pre-processing method for virtual dressing, a virtual dressing system, and a computer-readable storage medium.

### Description of Related Art

The virtual dressing market is rapidly growing, and with the development of e-commerce and Internet technology, more and more retailers and brands are utilizing virtual dressing technology to boost sales and enhance customer experience. At the same time, the impact of the pandemic has led to an increase in online shopping, allowing customers to try on virtual garments without leaving their homes, thereby enhancing their shopping experience. As a result, the demand for virtual dressing technology has surged.

Existing virtual dressing technologies are mostly presented in research papers, which often use standardized and high-quality image data for easy comparison between different methods. Since this kind of image data is pre-processed, the researchers only focus on the development of the core algorithm to optimize the final virtual fitting results.

However, practical usage of image data poses challenges as the quality may not match the standards of research papers. Moreover, the pre-processing methods required need to be handled separately, making it difficult to directly apply the outcomes of related technologies.

### SUMMARY

In view of this, the disclosure provides an image pre-processing method for virtual dressing, a virtual dressing system, and a computer-readable storage medium, which may be used to solve the above technical problems.

The embodiment of the disclosure provides an image pre-processing method for virtual dressing adapted for a virtual dressing system, which includes the following process. A cloth image including a cloth and a human body image including a human body are obtained. A human skeleton image corresponding to the human body is generated. A skeleton image area in the human skeleton image is determined based on the cloth image. A specific image area corresponding to the skeleton image area is cropped from the human body image.

The embodiment of the disclosure provides a virtual dressing system including a storage circuit and a processor. The storage circuit stores a code. The processor is coupled to the storage circuit and accesses the code to execute the following process. A cloth image including a cloth and a human body image including a human body are obtained. A human skeleton image corresponding to the human body is generated. A skeleton image area in the human skeleton image is determined based on the cloth image. A specific image area corresponding to the skeleton image area is cropped from the human body image.

The embodiment of the disclosure provides a computer-readable storage medium. The computer-readable storage medium records an executable computer program. The executable computer program is loaded by the virtual dressing system to execute the following process. A cloth image including a cloth and a human body image including a human body are obtained. A human skeleton image corresponding to the human body is generated. A skeleton image area in the human skeleton image is determined based on the cloth image. A specific image area corresponding to the skeleton image area is cropped from the human body image.

### BRIEF DESCRIPTION OF THE DRAWINGS

FIG. 1 is a schematic view of a virtual dressing system according to an embodiment of the disclosure.

FIG. 2A to FIG. 2C show virtual dressing application scenarios according to an embodiment of the disclosure.

FIG. 3 is a flowchart of an image pre-processing method for virtual dressing according to an embodiment of the disclosure.

FIG. 4A to FIG. 4E are schematic views of image pre-processing according to the first embodiment of the disclosure.

FIG. 5 is a flowchart of a method for removing character background according to an embodiment of the disclosure.

FIG. 6A to FIG. 6C are schematic views of removing character background according to the second embodiment of the disclosure.

FIG. 7 is a flowchart of a method for fixing cloth image aspect ratio according to an embodiment of the disclosure.

FIG. 8A to FIG. 8C are schematic views of fixing cloth image aspect ratio according to the third embodiment of the disclosure.

FIG. 9 is a schematic view of application results corresponding to different original images and original cloth images according to an embodiment of the disclosure.

### DESCRIPTION OF THE EMBODIMENTS

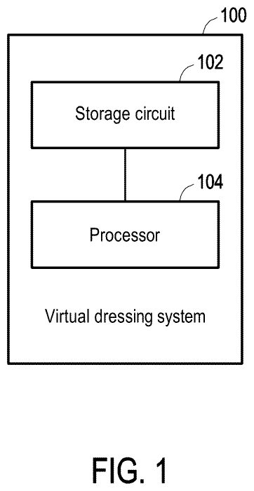

FIG. 1 is a schematic view of a virtual dressing system according to an embodiment of the disclosure. In different embodiments, a virtual dressing system 100 may be implemented as, for example, various intelligent devices and/or computer devices, but is not limited thereto.

In FIG. 1, the virtual dressing system 100 includes a storage circuit 102 and a processor 104.

The storage circuit 102 is, for example, any type of fixed or removable random access memory (RAM), read-only memory (ROM), flash memory, a hard disk or other similar devices or a combination of these devices, and may be configured to record multiple codes or modules.

The processor 104 is coupled to the storage circuit 102 and may be a general purpose processor, a special purpose processor, a conventional processor, a digital signal processor, multiple microprocessors, one or more microprocessors combined with digital signal processor cores, a controller, a microcontroller, an application specific integrated circuit (ASIC), a field programmable gate array (FPGA) circuit, any other kind of integrated circuit, a state machine, an advanced RISC machine (ARM) processor, and the like.

In the embodiment of the disclosure, the processor 104 may access the modules and codes recorded in storage circuit 102 to implement the method proposed by the disclosure, so that the virtual dressing system 100 may execute the relevant image processing method for virtual dressing, and then generate a virtual dressing result image.

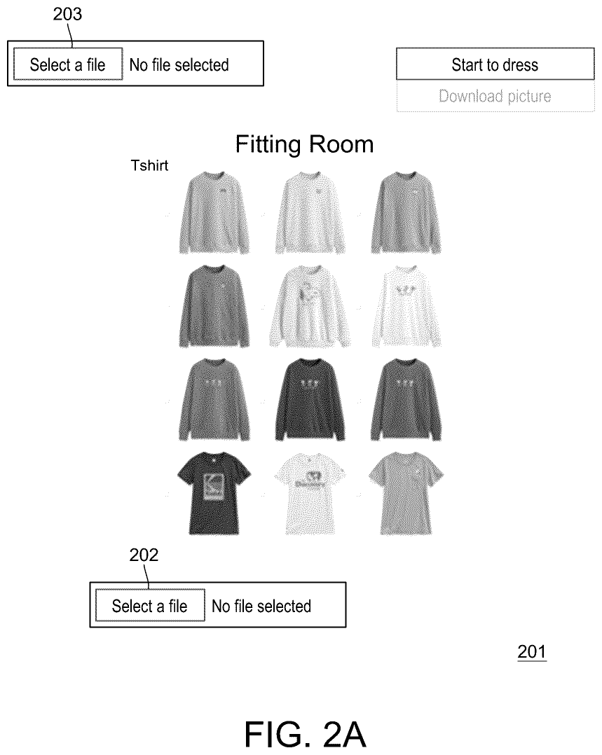

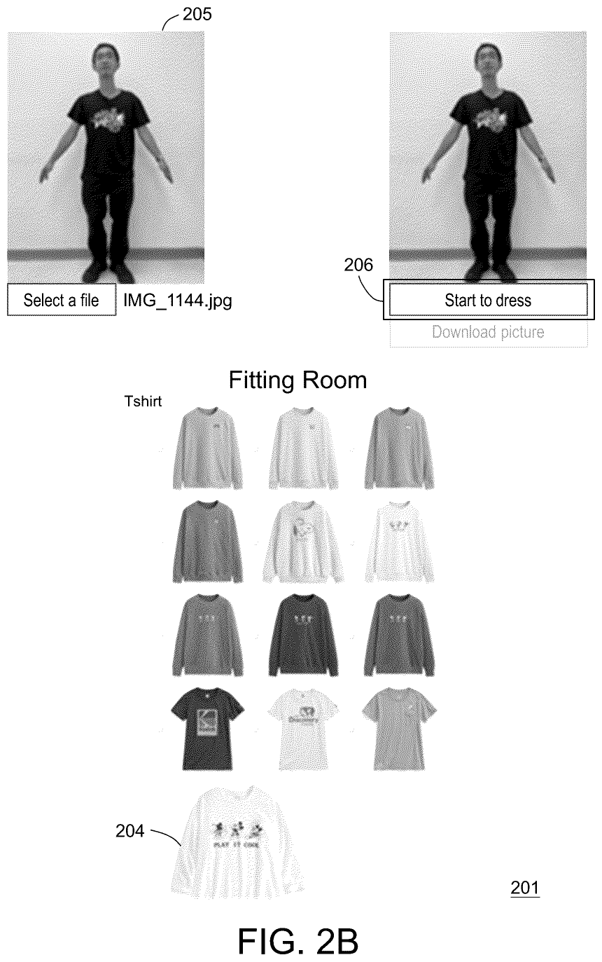

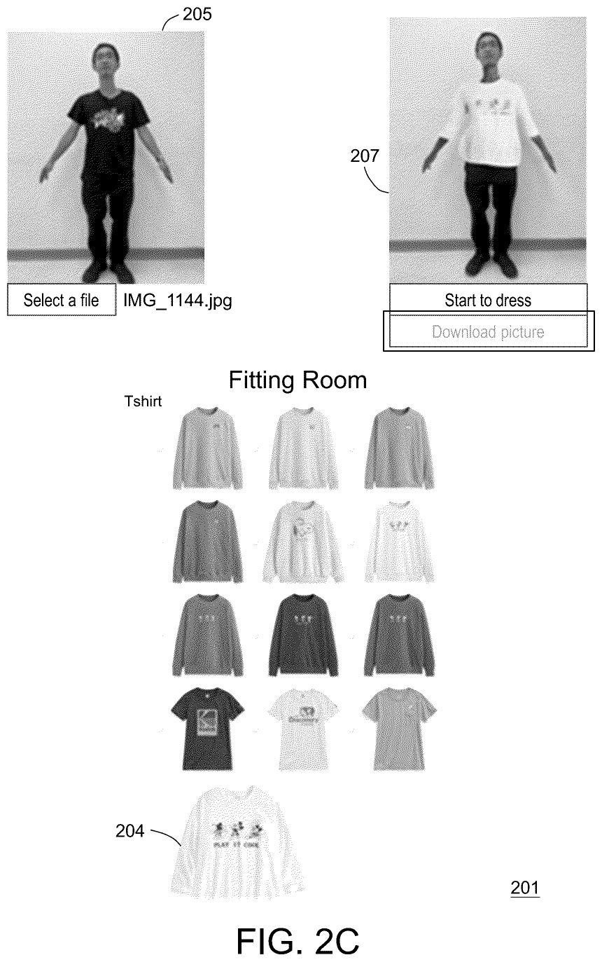

FIG. 2A to FIG. 2C show virtual dressing application scenarios according to an embodiment of the disclosure. In FIG. 2A, the user may, for example, select a cloth image (which may correspond to, for example, but not limited to, a cloth item on a shopping site) to be virtual dressed in an user interface 201 provided by the virtual dressing system 100 or upload the cloth image to be used for virtual dressing to the virtual dressing system 100 through an upload button 202.

In addition, the user may also upload a human body image including the human body to the virtual dressing system 100 through an upload button 203, so that the virtual dressing system 100 may virtually wear the cloth in the above cloth image on the human body in the human body image.

In FIG. 2B, it is assumed that the user uploads a cloth image 204 and a human body image 205 through the upload buttons 202 and 203, respectively. Then, the virtual dressing system 100 may display a trigger button 206 in the user interface 201 for the user to trigger the virtual dressing system 100 to execute the related image processing method for virtual dressing.

In FIG. 2C, after the user clicks the trigger button 206, the virtual dressing system 100 may, for example, virtually wear the cloth in the cloth image 204 on the human body in the human body image 205 through the above image processing method to generate a virtual dressing result image 207 for the user's reference. The user may also download the virtual dressing result image 207 for subsequent use, but not limited thereto.

In the embodiment of the disclosure, in order to enable the virtual dressing system 100 to provide a virtual dressing result image with better quality, the virtual dressing system 100 may execute an image pre-processing method for virtual dressing proposed by the disclosure, which is further described below.

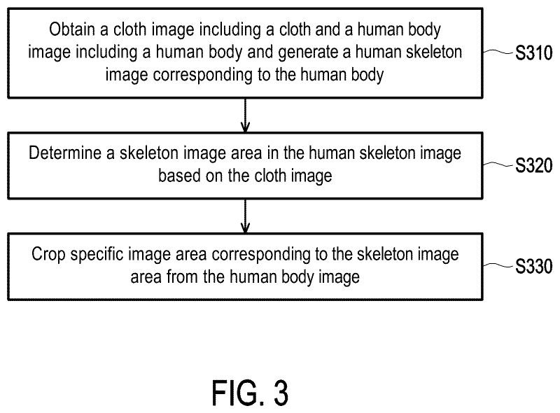

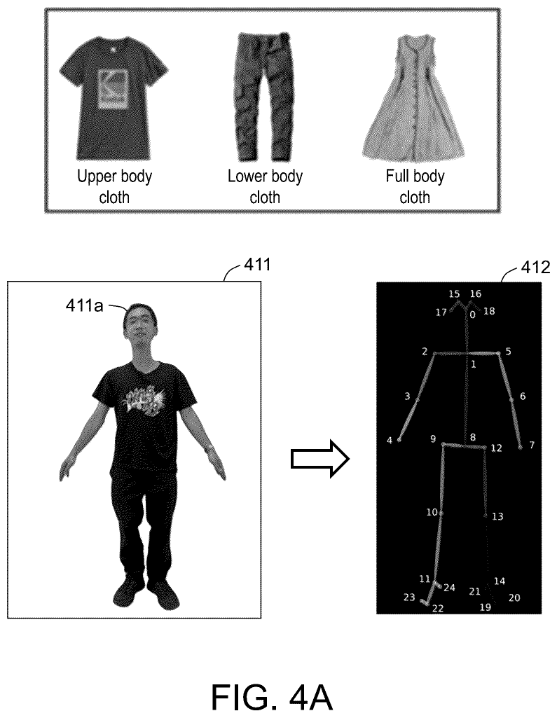

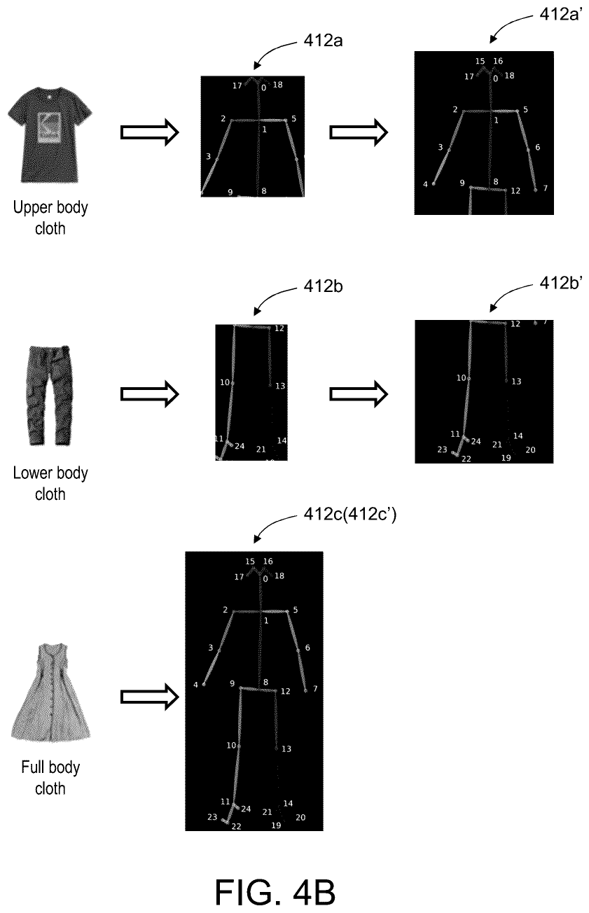

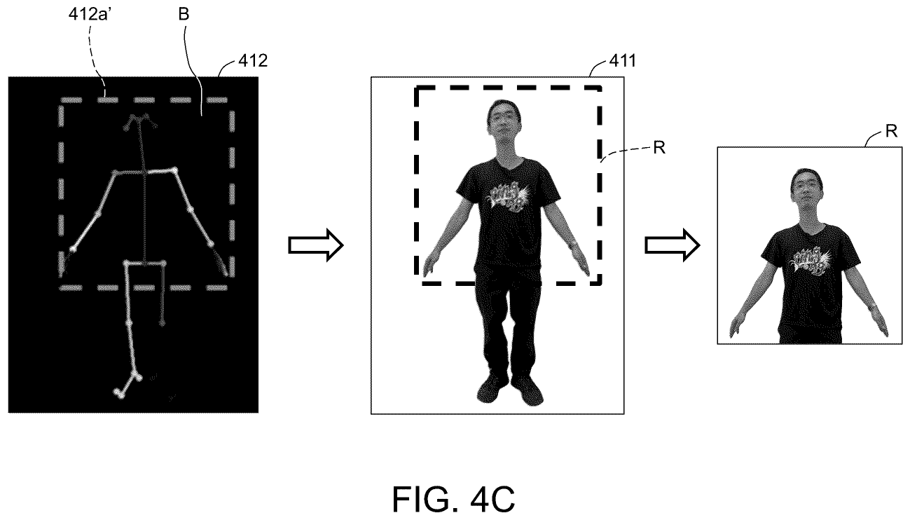

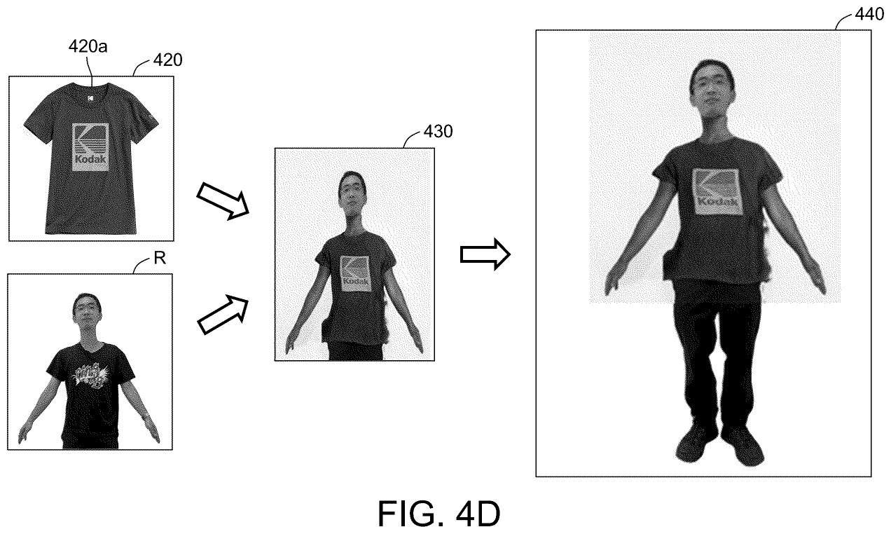

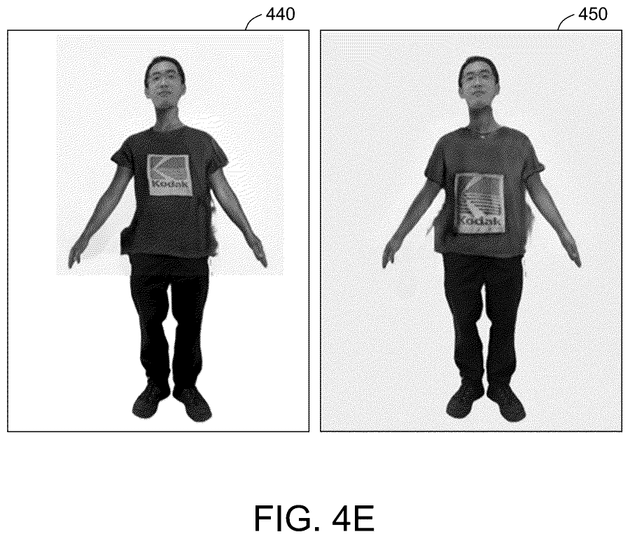

FIG. 3 is a flowchart of an image pre-processing method for virtual dressing according to an embodiment of the disclosure. The method of this embodiment may be executed by the virtual dressing system 100 in FIG. 1, and the details of each step in FIG. 3 are described below with the elements shown in FIG. 1. To enhance the understanding of the concept of the disclosure, further explanation is provided in accordance with FIG. 4A to FIG. 4E. FIG. 4A to FIG. 4E are schematic views of image pre-processing according to the first embodiment of the disclosure. First, in step S310, the processor 104 obtains the cloth image (hereinafter referred to as A) including the cloth (hereinafter referred to as C) and a human body image 411 including a human body 411a and generates a human skeleton image 412 corresponding to the human body 411a.

In FIG. 4A, the cloth type (hereinafter referred to as T) of the cloth C in the cloth image A under consideration is an upper body cloth (such as the t-shirt shown), a lower body cloth (such as the trousers shown), or a full body cloth (such as the dress shown), but not limited thereto. In different embodiments, the considered cloth image A may come from a shopping site or uploaded by the user.

In one embodiment, the human body image 411 may be uploaded by the user. In another embodiment, the user may also use an imaging device in a store to take a full-body shot as the human body image 411 when purchasing clothes in a cloth store. The considered cloth image A may be, for example, selected by the user from the website of the cloth store, or may be obtained by directly photographing the cloth in the cloth store by the aforementioned imaging device, but not limited thereto.

In one embodiment, the processor 104 may, for example, generate the human skeleton image 412 corresponding to the human body 411a based on a related human pose recognition algorithm (such as DeepPose), but it is not limited thereto.

In FIG. 4A, the human skeleton image 412 includes, for example, nodes corresponding to multiple nodes on the human body 411a. Each of the nodes may have a corresponding number, and the relevant principle of numbering may depend on the human pose recognition algorithm selected.

Afterwards, in step S320, the processor 104 determines a skeleton image area (hereinafter referred to as B) in the human skeleton image 412 based on the cloth image A.

In one embodiment, the processor 104 may identify the cloth type T of the cloth C in the cloth image A and determine the above-mentioned skeleton image area B in the human skeleton image 412 based on the cloth type T.

In different embodiments, the processor 104 may identify the cloth type T of the cloth C in different ways. In one embodiment, if the cloth C is selected from the site of the cloth store, the user (or other relevant personnel) may use a relevant reader (such as the barcode reader) to directly read the recognize information (such as the label barcode) of the cloth C. The above-mentioned reader may provide the read recognize information to the virtual dressing system 100. Afterwards, the processor 104 may query a cloth database of the cloth store to obtain the relevant information of the cloth C, such as the cloth type T, but not limited thereto.

In another embodiment, the processor 104 may feed the cloth image A into an image classification model (hereinafter referred to as M). The image classification model M predicts the cloth type T of the cloth C in response to the cloth image A.

In different embodiments, the image classification model M may be implemented based on architectures such as visual geometry group (VGG), MobileNet, EfficientNet, but is not limited thereto.

In one embodiment, to enable the image classification model M with the aforementioned capabilities, during the training process of the image classification model M, the designer may feed specially designed training data into the image classification model M to facilitate the learning process. For example, after obtaining a labeled cloth image corresponding to a specific cloth type (such as the upper body cloth, lower body cloth, or full body cloth), which may be used as training data to feed into the image classification model M during the training process, this allows the image classification model M to learn the characteristics associated with each cloth type in the cloth image.

Based on similar concepts, after feeding the cloth images corresponding to different cloth types into the image classification model M in training, the image classification model M may learn the characteristics of the cloth images corresponding to different cloth types. Based on this, in response to an unknown cloth image being fed into the trained image classification model M, the image classification model M may predict/determine the corresponding cloth type accordingly, but it is not limited thereto.

In one embodiment, the processor 104 may determine an area of interest corresponding to an upper body skeleton, a lower body skeleton, or a full body skeleton in the human skeleton image 412 based on the cloth type T, as shown in FIG. 4B.

In FIG. 4B, in response to determining that the cloth type T is the upper body cloth, the processor 104 may determine an area of interest 412a corresponding to the upper body skeleton (such as nodes of numbers 0, 1, 2, 3, 4, 5, 6, 7, 8, 9, 12, 15, 16, 17, and 18) in the human skeleton image 412. In response to determining that the cloth type T is the lower body cloth, the processor 104 determines an area of interest 412b corresponding to the lower body skeleton (such as nodes of numbers 8, 9, 10, 11, 12, 13, 14, 19, 20, 21, 22, 23, and 24) in the human skeleton image 412. In response to determining that the cloth type T is the full body cloth, the processor 104 determines an area of interest 412c corresponding to the full body skeleton (such as the entire human skeleton image 412) in the human skeleton image 412.

After that, the processor 104 may adjust the considered area of interest according to a specific ratio and determine an image area corresponding to an adjusted area of interest in the human skeleton image 412 as the skeleton image area B. In one embodiment, the adjusted area of interest may not exceed the size of the human skeleton image 412.

For example, in response to the considered area of interest being the area of interest 412a (i.e., the scenario where the cloth type T is the upper body cloth), then the processor 104 may multiply the area of interest 412a by a specific ratio (such as 1.4) to adjust the area of interest 412a to the area of interest 412a′. Afterwards, the processor 104 may determine the image area corresponding to the area of interest 412a′ as the skeleton image area B.

For another example, in response to the considered area of interest being the area of interest 412b (i.e., the scenario where the cloth type T is the lower body cloth), then the processor 104 may multiply the area of interest 412b by a specific ratio (such as 1.4) to adjust the area of interest 412b to the area of interest 412b′. Afterwards, the processor 104 may determine the image area corresponding to the area of interest 412b′ as the skeleton image area B.

For yet another example, in response to the considered area of interest being the area of interest 412c (i.e., the scenario where the cloth type T is the full body cloth), then the processor 104 may multiply the area of interest 412c by a specific ratio (such as 1) to adjust the area of interest 412c to the area of interest 412c′, but it is not limited thereto. Afterwards, the processor 104 may determine the image area corresponding to the area of interest 412c′ as the skeleton image area B.

Next, in step S330, the processor 104 crops specific image area (hereinafter referred to as R) corresponding to the skeleton image area B from the human body image 411.

In the scenario in FIG. 4C, it is assumed that the adjusted area of interest considered is the area of interest 412a′ (i.e., the scenario where the cloth type T is the upper body cloth), then the processor 104 may determine the skeleton image area B in the human skeleton image 412 accordingly. Afterwards, the processor 104 may crop the specific image area R corresponding to the skeleton image area B from the human body image 411.

In the embodiment of the disclosure, by adjusting the area of interest based on the above-mentioned specific ratio, the truncated body part (such as the truncated top of the head and/or the end of the limb) may be avoided in the cropped specific image area R.

In one embodiment, after obtaining the specific image area R including the body part (such as the upper body), the processor 104 may virtually wear the cloth C in the cloth image A on the body part in the specific image area R and combine the body part wearing the cloth C with the human body image 411 to generate a virtual dressing result image.

In the scenario of FIG. 4D, it is assumed that the considered cloth image A is a cloth image 420 including a cloth 420a (such as the upper body cloth), after obtaining the specific image area R, the processor 104 may virtually wear the cloth 420a on the body part (such as the upper body) in the specific image area R to generate a reference result image 430.

In different embodiments, the processor 104 may utilize various existing virtual dressing algorithms (such as “High-Resolution Virtual Try-On with Misalignment and Occlusion-Handled Conditions”, “Style-Based Global Appearance Flow for Virtual Try-On”) to virtually wear the cloth 420a on a specific body part in the specific image area R.

Afterwards, the processor 104 may combine the reference result image 430 and the human body image 411 into a virtual dressing result image 440 (which may be referred to as a first virtual dressing result image). For example, the processor 104 may cover the specific image area R in the human body image 411 with the reference result image 430 to obtain the virtual dressing result image 440.

Through the method shown in FIG. 3, the virtual dressing result image 440 may provide a better virtual dressing effect, thereby improving user experience.

In FIG. 4E, the virtual dressing result image 450 is, for example, obtained without image pre-processing using the method described in FIG. 3. Instead, an existing virtual dressing algorithm is directly applied to virtually wear the cloth 420a in the cloth image 420 on the human body 411a in the human body image 411.

It may be seen from FIG. 4E that the position of the cloth pattern in the virtual dressing result image 450 is obviously low, thus unable to provide a satisfactory virtual dressing effect. In contrast, the virtual dressing result image 440 may provide a more accurate virtual dressing effect. It may be seen that, after obtaining the specific image area R corresponding to the skeleton image area B through the method shown in FIG. 3 (it may also be understood as obtaining the corresponding upper body image area, lower body image area, or full body image area based on the cloth type T), the subsequent virtual dressing algorithm may be used to virtually dress the cloth 420a in the cloth image 420 on the body part in the specific image area R more accurately. Thereby, a better virtual dressing effect may be provided.

In the above embodiment, the considered human body image 411 is of a type that has no background (or has a relatively simple background), and the method shown in FIG. 3 may be directly applied. However, for an image with a more complex background, the complexity of the background leads to uncertainty in the virtual dressing result, which may lead to a decrease in the quality of the final virtual dressing result. In view of this, the embodiment of the disclosure proposes another method for removing character background in an attempt to solve the above technical problems.

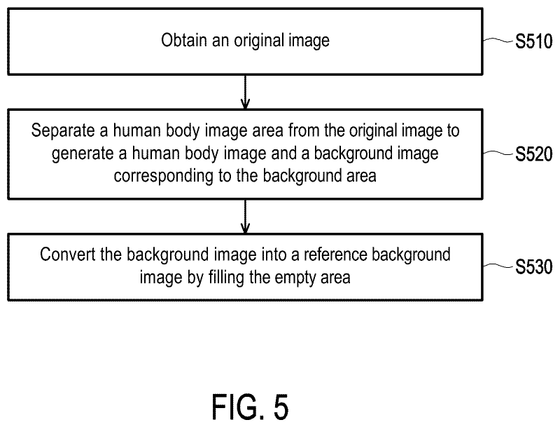

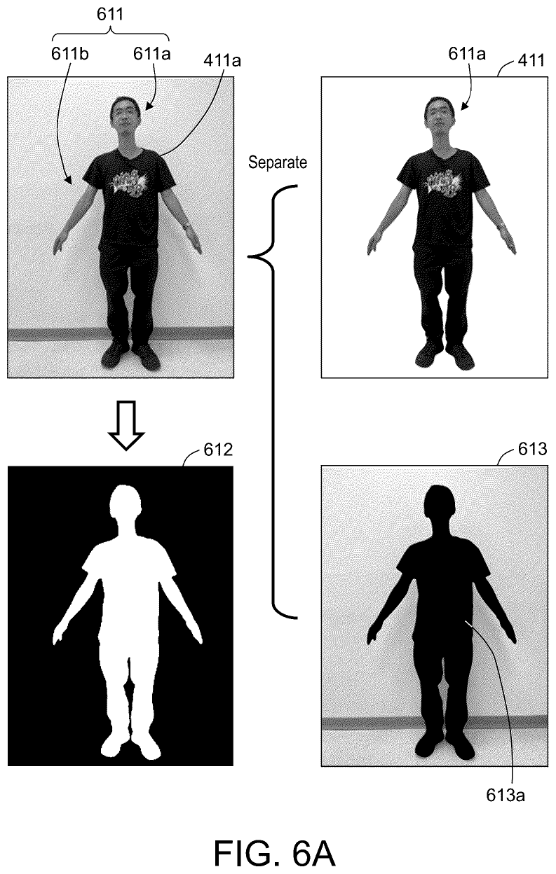

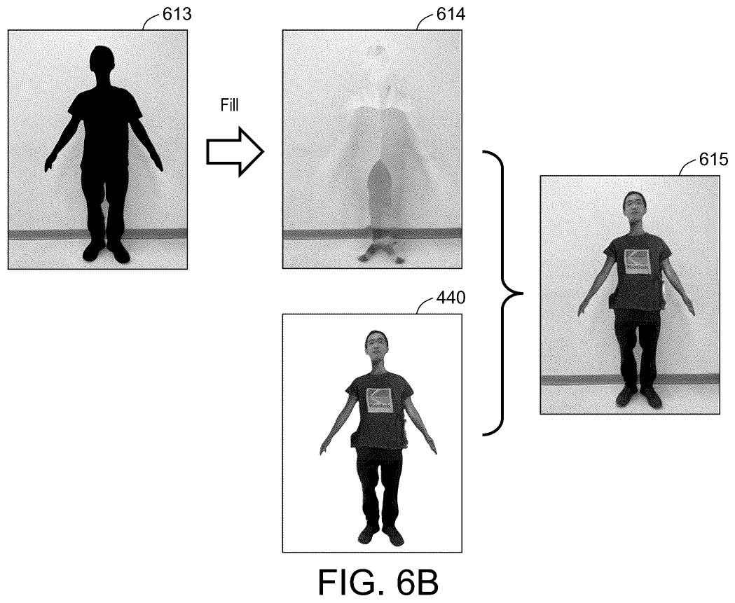

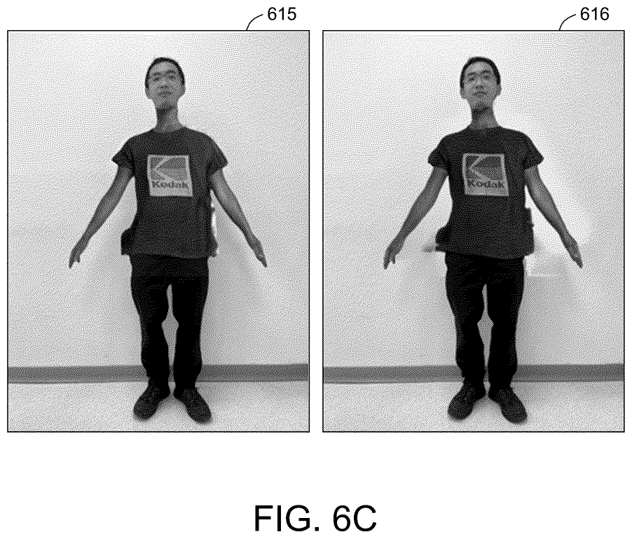

FIG. 5 is a flowchart of a method for removing character background according to an embodiment of the disclosure. The method of this embodiment may be executed by the virtual dressing system 100 in FIG. 1, and the details of each step in FIG. 5 are described below with the elements shown in FIG. 1. To enhance the understanding of the concept of the disclosure, further explanation is provided in accordance with FIG. 6A to FIG. 6C. FIG. 6A to FIG. 6C are schematic views of removing character background according to the second embodiment of the disclosure.

First, in step S510, the processor 104 obtains an original image 611. The original image 611 includes a background area 611b (such as a white wall) and a human body image area 611a corresponding to the human body 411a. In this embodiment, the original image 611 is, for example, uploaded by the user or taken on-site at the cloth store, but it is not limited thereto.

In one embodiment, the processor 104 may, for example, execute an existing character area segmentation algorithm based on the original image 611 to obtain a character area 612 and determine a human body image area 611a and a background area 611b in the original image 611 accordingly.

In step S520, the processor 104 separates the human body image area 611a from the original image 611 to generate a human body image 411 and a background image 613 corresponding to the background area 611b. In FIG. 6A, the background image 613 may include an empty area 613a corresponding to the human body image area 611a, and the processor 104 may fill the empty area 613a with black pixels. In addition, after separating the human body image area 611a from the original image 611, the processor 104 may fill the portion corresponding to the background area 611b with white pixels to form the human body image 411, but it is not limited thereto.

In step S530, the processor 104 converts the background image 613 into a reference background image 614 by filling the empty area 613a, as shown in FIG. 6B. In one embodiment, the processor 104 may fill the empty area 613a based on the Inpaint technique or other similar filling techniques, but is not limited thereto.

In the embodiment of FIG. 6B, the processor 104 may also generate a virtual dressing result image 615 (which may be referred to as a second virtual dressing result image) by combining the virtual dressing result image 440 with the reference background image 614.

Through the method shown in FIG. 5, the virtual dressing result image 615 may provide a better virtual dressing effect, thereby improving user experience.

In FIG. 6C, the virtual dressing result image 616 is, for example, obtained without removing character background using the method described in FIG. 5. Instead, an existing virtual dressing algorithm is directly applied to virtually wear the cloth 420a in the cloth image 420 on the human body 411a in the original image 611.

It may be seen from FIG. 6C that the background near the hand in the virtual dressing result image 615 has obvious noise, thus unable to provide a satisfactory virtual dressing effect. In contrast, the virtual dressing result image 614 may avoid excessive noise in the background, thereby providing a better virtual dressing effect.

In some embodiments, the variations in the way different clothing brands capture their cloth images may result in differences in the final virtual dressing results. For example, in response to different cloth images have different aspect ratios due to different shooting methods, the final virtual dressing result may not be ideal.

In view of this, the embodiment of the disclosure proposes another method for fixing cloth image aspect ratio in an attempt to solve the above technical problems.

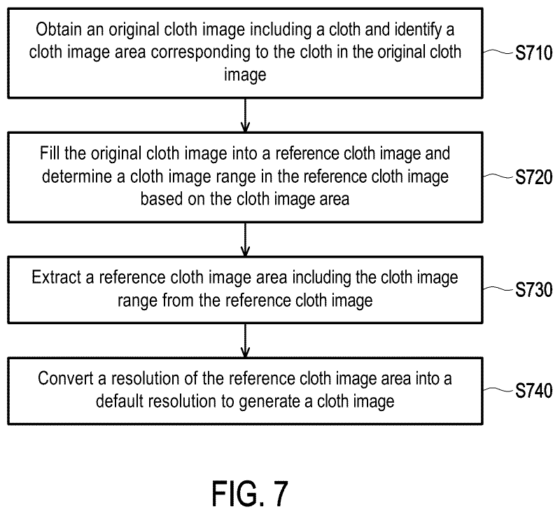

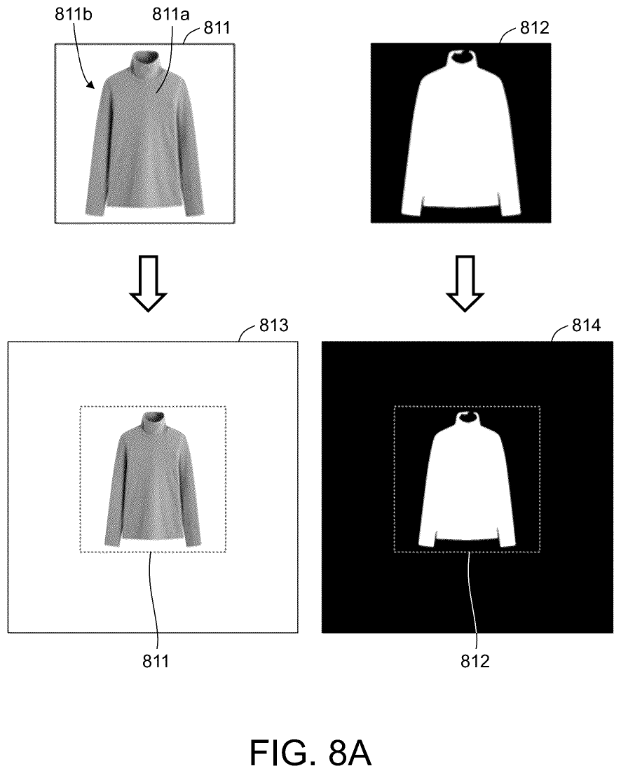

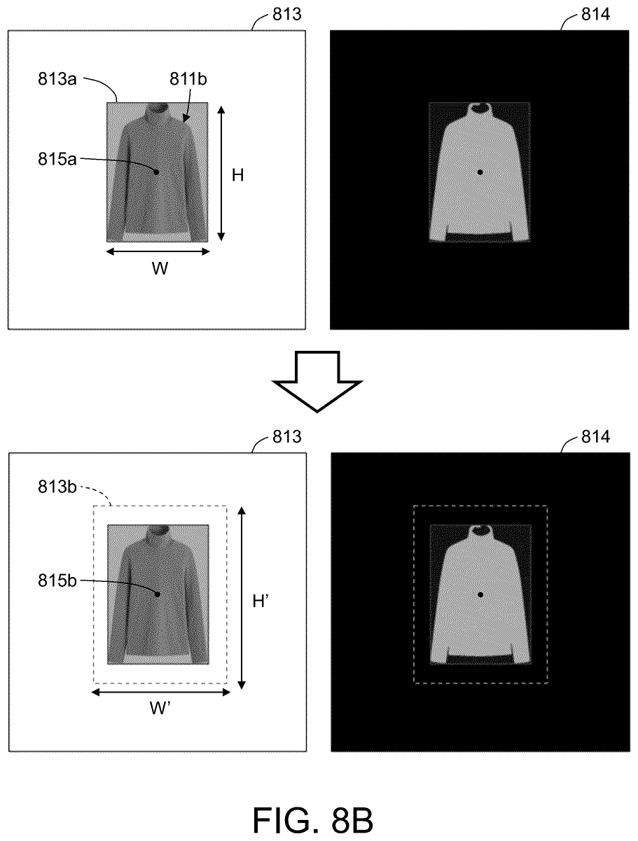

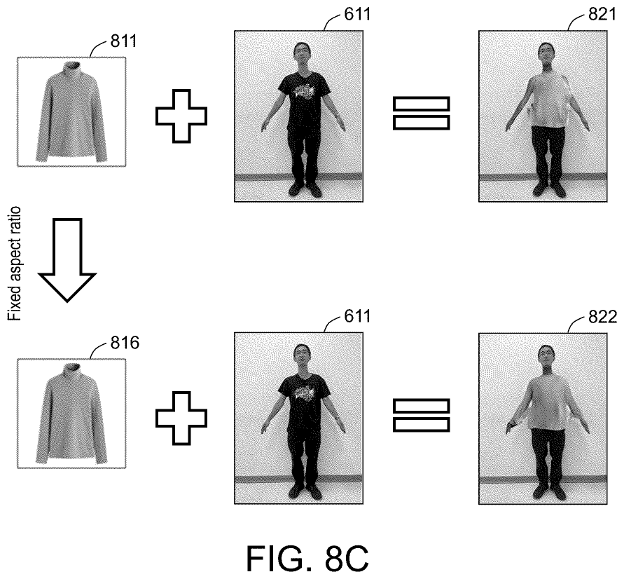

FIG. 7 is a flowchart of a method for fixing cloth image aspect ratio according to an embodiment of the disclosure. The method of this embodiment may be executed by the virtual dressing system 100 in FIG. 1, and the details of each step in FIG. 7 are described below with the elements shown in FIG. 1. To enhance the understanding of the concept of the disclosure, further explanation is provided in accordance with FIG. 8A to FIG. 8C. FIG. 8A to FIG. 8C are schematic views of fixing cloth image aspect ratio according to the third embodiment of the disclosure.

First, in step S710, the processor 104 obtains an original cloth image 811 including a cloth 811a and identifies a cloth image area 811b corresponding to the cloth 811a in the original cloth image 811.

In one embodiment, the processor 104 may, for example, execute an existing cloth area segmentation algorithm (which may be the same as the above-mentioned character area segmentation algorithm) based on the original cloth image 811 to obtain a cloth area 812 and determine a cloth image area 811b in the original cloth image 811.

In step S720, the processor 104 fills the original cloth image 811 into a reference cloth image 813 and determines a cloth image range 813a in the reference cloth image 813 based on the cloth image area 811b. In one embodiment, the processor 104 may double the height and width of the original cloth image 811 (with a resolution of, for example, 500×500) and fill the portion that does not belong to the original cloth image 811 with white pixels to form the reference cloth image 813 (with a resolution of, for example, 1000×1000). Similarly, the processor 104 may also fill the cloth area 812 accordingly to form an image 814 (with a resolution of, for example, 1000×1000).

Afterwards, the processor 104 may use a rectangle frame as the cloth image range 813a. The upper, lower, left, and right sides of the rectangle correspond to the uppermost, lowermost, leftmost, and rightmost pixels of the cloth image area 811b respectively, but it is not limited thereto.

In step S730, the processor 104 extracts a reference cloth image area 813b including the cloth image range 813a from the reference cloth image 813. The reference cloth image area 813 has a default aspect ratio (such as height:width=4:3).

In FIG. 8B, the reference cloth image area 813b has a specific height H′ and a specific width W′.

In one embodiment, in response to determining that an aspect ratio of the cloth image range 813a satisfies a default condition (such as an aspect ratio of greater than 1.33 times), the processor 104 expands a width W of the cloth image range 813a by a first default multiple (such as 1.25 times) to determine the specific width W′ and expands the specific width W′ by a second default multiple (such as 4/3 times) to determine the specific height H′.

In another embodiment, in response to determining that the aspect ratio of the cloth image range 813a does not satisfy the default condition (i.e., the aspect ratio is not greater than 1.33 times), the processor 104 expands a height H of the cloth image range 813a by the first default multiple to determine the specific height H′ and expands the specific height H′ by the second default multiple to determine the specific width W′.

In addition, in FIG. 8B, a center point 815b of the reference cloth image area 813b corresponds to a center point 815a of the cloth image range 813a, but it is not limited thereto.

Afterwards, in step S740, the processor 104 converts a resolution of the reference cloth image area 813b into a default resolution (such as 1024×768) to generate a cloth image 816, as shown in FIG. 8C.

In FIG. 8C, the processor 104 may execute a virtual dressing algorithm based on the original cloth image 811 and the original image 611 to obtain a virtual dressing result image 821. In addition, the processor 104 may execute a virtual dressing algorithm based on the cloth image 816 and the original image 611 to obtain a virtual dressing result image 822.

From FIG. 8C, it may be seen that in response to the method shown in FIG. 7 not being executed prior to directly executing the virtual dressing algorithm based on the original cloth image 811 and the original image 611, it may result in less than ideal effects in the virtual dressing result image 821 (such as sleeves not correctly matching the arms). However, in response to the method shown in FIG. 7 being executed for converting the original cloth image 811 into the cloth image 816 prior to executing the virtual dressing algorithm, it may result in ideal effects in the virtual dressing result image 822 (such as sleeves correctly matching the arms).

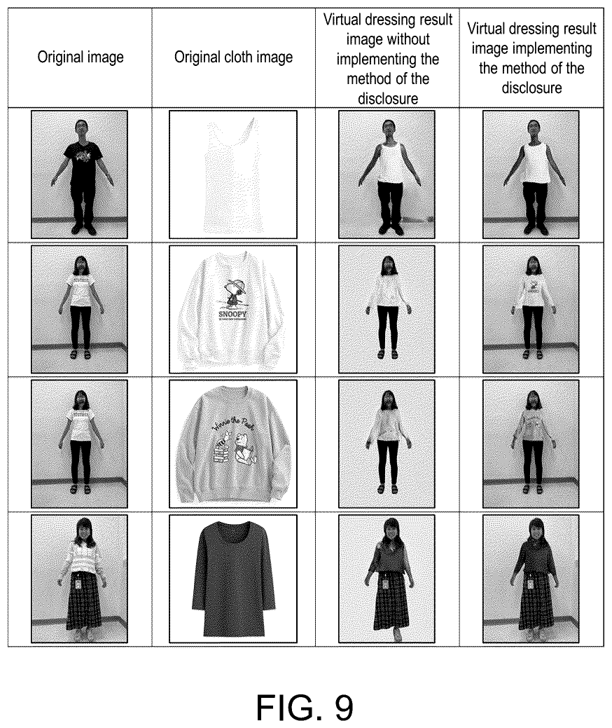

FIG. 9 is a schematic view of application results corresponding to different original images and original cloth images according to an embodiment of the disclosure.

It may be seen from FIG. 9 that, compared to executing the virtual dressing algorithm directly based on the original image and the original cloth image, executing the image pre-processing method for virtual dressing, the method for removing character background, and/or the method for fixing cloth image aspect ratio in the embodiment of the disclosure prior to executing the virtual dressing algorithm provides a better virtual dressing result image.

In other embodiments, after executing the image pre-processing method for virtual dressing, the method for removing character background, and/or the method for fixing cloth image aspect ratio in the embodiment of the disclosure, other pre-processing may also be executed on the obtained cloth image (such as the cloth image 816 in FIG. 8C) and/or the specific image area corresponding to the skeleton image area (such as the specific image area R in FIG. 4D). The pre-processing method may include various virtual dressing algorithms such as High-Resolution Virtual Try-On with Misalignment and Occlusion-Handled Conditions, Style-Based Global Appearance Flow for Virtual Try-On, but it is not limited theretol.

In summary, the embodiment of the disclosure may be implemented through the image pre-processing method for virtual dressing, the method for removing character background, and/or the method for fixing cloth image aspect ratio to improve the virtual dressing result image provided by the subsequent virtual dressing algorithm, so as to provide a better user experience.

In addition, since the quality of the virtual dressing result image may be improved, the method in the embodiment of the disclosure may at least achieve the following effects. (1) Enhance shopping experience: Allow consumers to try on clothes without leaving their homes, thus improving their online shopping experience. (2) Reduce return rates: Enable consumers to preview the fitting effect of the clothes and determine if it aligns with their personal style, thereby reducing the rate of returns due to dissatisfaction. (3) Increase sales revenue: Compared to clothing brands without virtual dressing products, this feature may serve as a promotional attraction to attract consumers to use the virtual dressing product and subsequently boosting sales revenue. (4) Improve customer retention: Combine with clothing recommendation algorithms to offer real-time try-on experiences for recommended clothing items, enticing consumers to make purchases and increasing their loyalty to the brand. (5) Cost reduction: Through virtual dressing technology, inventory costs for clothing stores are reduced and product damage caused by physical try-ons is avoided, such as leaving lipstick marks on the clothes or rendering try-on clothes only suitable for sale as defective products.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. An image pre-processing method for virtual dressing, adapted for a virtual dressing system, comprising:
obtaining a cloth image comprising a cloth and a human body image comprising a human body and generating a human skeleton image corresponding to the human body;
determining a skeleton image area in the human skeleton image based on the cloth image; and
cropping a specific image area corresponding to the skeleton image area from the human body image.

2. The method according to claim 1, wherein steps of determining the skeleton image area from the human skeleton image based on the cloth image comprise:
identifying a cloth type of the cloth in the cloth image; and
determining the skeleton image area in the human skeleton image based on the cloth type.

3. The method according to claim 2, wherein steps of determining the skeleton image area in the human skeleton image based on the cloth type comprise:
determining an area of interest corresponding to an upper body skeleton, a lower body skeleton, or a full body skeleton in the human skeleton image based on the cloth type; and
adjusting the area of interest according to a specific ratio and determining an image area corresponding to an adjusted area of interest in the human skeleton image as the skeleton image area.

4. The method according to claim 3, wherein steps of determining the area of interest corresponding to the upper body skeleton, the lower body skeleton, or the full body skeleton in the human skeleton image based on the cloth type comprise:
determining the area of interest corresponding to the upper body skeleton in the human skeleton image in response to determining that the cloth type is an upper body cloth;
determining the area of interest corresponding to the lower body skeleton in the human skeleton image in response to determining that the cloth type is a lower body cloth; and
determining the area of interest corresponding to the full body skeleton in the human skeleton image in response to determining that the cloth type is a full body cloth.

5. The method according to claim 2, wherein steps of identifying the cloth type of the cloth in the cloth image comprise:
feeding the cloth image into an image classification model, wherein the image classification model predicts the cloth type of the cloth in response to the cloth image; or
obtaining a recognize information of the cloth and determining the cloth type of the cloth accordingly.

6. The method according to claim 1, further comprising:
obtaining an original image, wherein the original image comprises a background area and a human body image area corresponding to the human body;
separating the human body image area from the original image to produce the human body image and a background image corresponding to the background area, wherein the background image comprises an empty area corresponding to the human body image area;
converting the background image into a reference background image by filling the empty area.

7. The method according to claim 1, wherein the specific image area comprises a body part, and the method further comprises:
virtually wearing the cloth in the cloth image on the body part in the specific image area to generate a reference result image; and
combining the reference result image with the human body image into a first virtual dressing result image.

8. The method according to claim 7, further comprising:
generating a second virtual dressing result image by combining the first virtual dressing result image with a reference background image.

9. The method according to claim 1, further comprising:
obtaining an original cloth image comprising the cloth and identifying a cloth image area corresponding to the cloth in the original cloth image;
filling the original cloth image into a reference cloth image and determining a cloth image range in the reference cloth image based on the cloth image area;
extracting a reference cloth image area comprising the cloth image range from the reference cloth image, wherein the reference cloth image area has a default aspect ratio; and
converting a resolution of the reference cloth image area into a default resolution to generate the cloth image.

10. The method according to claim 9, wherein the reference cloth image area has a specific height and a specific width, and the method further comprises:
expanding a width of the cloth image range by a first default multiple to determine the specific width and expanding the specific width by a second default multiple to determine the specific height in response to determining that an aspect ratio of the cloth image range satisfies a default condition;
expanding a height of the cloth image range by the first default multiple to determine the specific height and expanding the specific height by the second default multiple to determine the specific width in response to determining that the aspect ratio of the cloth image range does not satisfy the default condition;
wherein a center point of the reference cloth image area corresponds to a center point of the cloth image range.

11. A virtual dressing system, comprising:
a non-transitory storage circuit, storing a code; and
a processor, coupled to the non-transitory storage circuit and accessing the code to execute:
obtaining a cloth image comprising a cloth and a human body image comprising a human body and generating a human skeleton image corresponding to the human body;
cropping a skeleton image area from the human skeleton image based on the cloth image; and
cropping a specific image area corresponding to the skeleton image area from the human body image.

12. The virtual dressing system according to claim 11, wherein the processor is configured to execute:
identifying a cloth type of the cloth in the cloth image; and
determining the skeleton image area in the human skeleton image based on the cloth type.

13. The virtual dressing system according to claim 12, wherein the processor is configured to execute:
determining an area of interest corresponding to an upper body skeleton, a lower body skeleton, or a full body skeleton in the human skeleton image based on the cloth type; and
adjusting the area of interest according to a specific ratio and determining an image area corresponding to the area of interest in the human skeleton image as the skeleton image area.

14. The virtual dressing system according to claim 13, wherein the processor is configured to execute:
determining the area of interest corresponding to the upper body skeleton in the human skeleton image in response to determining that the cloth type is an upper body cloth;
determining the area of interest corresponding to the lower body skeleton in the human skeleton image in response to determining that the cloth type is a lower body cloth; and
determining the area of interest corresponding to the full body skeleton in the human skeleton image in response to determining that the cloth type is a full body cloth.

15. The virtual dressing system according to claim 12, wherein the processor is configured to execute:
feeding the cloth image into an image classification model, wherein the image classification model predicts the cloth type of the cloth in response to the cloth image; or
obtaining a recognize information of the cloth and determining the cloth type of the cloth accordingly.

16. The virtual dressing system according to claim 11, wherein the processor is further configured to execute:
obtaining an original image, wherein the original image comprises a background area and a human body image area corresponding to the human body;
separating the human body image area from the original image to produce the human body image and a background image corresponding to the background area, wherein the background image comprises an empty area corresponding to the human body image area;
converting the background image into a reference background image by filling the empty area.

17. The virtual dressing system according to claim 11, wherein the specific image area comprises a body part, and the processor is further configured to execute:
virtually wearing the cloth in the cloth image on the body part in the specific image area to generate a reference result image; and
combining the reference result image with the human body image into a first virtual dressing result image; and
generating a second virtual dressing result image by combining the first virtual dressing result image with a reference background image.

18. The virtual dressing system according to claim 11, wherein the processor is further configured to execute:
obtaining an original cloth image comprising the cloth and identifying a cloth image area corresponding to the cloth in the original cloth image;
filling the original cloth image into a reference cloth image and determining a cloth image range in the reference cloth image based on the cloth image area;
extracting a reference cloth image area comprising the cloth image range from the reference cloth image, wherein the reference cloth image area has a default aspect ratio; and
converting a resolution of the reference cloth image area into a default resolution to generate the cloth image.

19. The virtual dressing system according to claim 18, wherein the reference cloth image area has a specific height and a specific width, and the processor is further configured to execute:
expanding a width of the cloth image range by a first default multiple to determine the specific width and expanding the specific width by a second default multiple to determine the specific height in response to determining that an aspect ratio of the cloth image range satisfies a default condition;
expanding a height of the cloth image range by the first default multiple to determine the specific height and expanding the specific height by the second default multiple to determine the specific width in response to determining that the aspect ratio of the cloth image range does not satisfy the default condition;
wherein a center point of the reference cloth image area corresponds to a center point of the cloth image range.

20. A non-transitory computer-readable storage medium, wherein the non-transitory computer-readable storage medium records an executable computer program, and the executable computer program is loaded by a virtual dressing system to execute:
obtaining a cloth image comprising a cloth and a human body image comprising a human body and generating a human skeleton image corresponding to the human body;
cropping a skeleton image area from the human skeleton image based on the cloth image; and
cropping a specific image area corresponding to the skeleton image area from the human body image.
